(19) United States
(12) Patent Application Publication
(10) Pub. No.: US 2015/0285484 A1
(43) Pub. Date: Oct. 8, 2015

(54) LIGHTING DEVICE WITH UNIFORM ILLUMINATION

(71) Applicant: Ledyoung Technology Corporation, Tao-Yuan City (TW)

(72) Inventor: Yen-Chou HSU, Tao-Yuan City (TW)

(21) Appl. No.: 14/668,977

(22) Filed: Mar. 25, 2015

(30) Foreign Application Priority Data
Apr. 2, 2014 (TW) 103205636

(51) Int. Cl. F21V 29/70; F21V 23/06; F21V 8/00

(52) U.S. Cl. CPC F21V 29/70; G02B 6/0001; F21V 23/06; F21Y 2101/02

(57) ABSTRACT

A lighting device with uniform illumination includes a lamp holder including an electric connector, a heat sink mounted at the electric connector and a light-emitting diode located in the heat sink, and a light guide prism including a reflective layer and a light-incident surface respectively located at two opposite ends thereof, a light-emitting surface extending around the periphery thereof and a plurality of recessed refractive surface portions located in the light-emitting surface for refracting and diffusing light that is emitted by the light-emitting diode through the light-incident surface and then reflected by the reflective layer so that the light guide prism can provide enhanced uniformity and brightness of lateral illumination. Further, the lighting device is easy to fabricate.

### BACKGROUND OF THE INVENTION

1. Field of the Invention

The present invention relates to lighting technology and more particularly, to a lighting device with uniform illumination that uses a light-emitting device as a light source for giving off light, providing enhanced uniformity and brightness of lateral illumination.

2. Description of the Related Art

For the advantages of high energy efficiency, high cost effectiveness and long-term durability, light-emitting diode has been widely used to replace conventional incandescent lamp for lighting. Regular LED-based lighting devices commonly comprise a lamp holder, a LED or multiple LEDs mounted in the lamp holder, and a light-transmissive lampshade mounted at the lamp holder over the LED. During operation, the light emitted by the LED or LEDs goes upwardly through the light-transmissive lampshade to produce an illumination effect. Further, color LEDs can be used to emit color light, creating a dramatic illumination effect However, the effective lighting range of LEDs is limited.

When the light emitted by the LEDs goes upwards, the brightness is concentrated in the top side of the lampshade, resulting in uneven lateral illumination. Thus, the conventional LED-based lighting devices cannot effectively exhibit their features, exhibiting poor aesthetics.

### SUMMARY OF THE INVENTION

The present invention has been accomplished under the circumstances in view. It is therefore the main object of the present invention to provide a lighting device with uniform illumination, which can provide enhanced uniformity and brightness of lateral illumination, creating a dramatic illumination effect.

To achieve this and other objects of the present invention, a lighting device comprises a lamp holder and a light guide prism. The lamp holder comprises an electric connector, a heat sink mounted at the electric connector, and a light-emitting diode located in the electric connector. Thus, heat generated during the operation of the light-emitting diode can be transferred to the heat sink for quick dissipation. The light guide prism comprises a reflective layer and a light-incident surface respective located at two opposite ends thereof, a light-emitting surface extending around the periphery thereof, and a plurality of recessed refractive surface portions located in the light-emitting surface for refracting and diffusing light. Thus, the light emitted by the light-emitting diode is projected into the light-incident surface toward the reflective layer, and then reflected by the reflective layer toward the light-emitting surface and the recessed refractive surface portions and then refracted and diffused out of the periphery of the light guide prism in a uniform manner by the recessed refractive surface portions. Therefore, the light guide prism can provide enhanced uniformity and brightness of lateral illumination.

### BRIEF DESCRIPTION OF THE DRAWINGS

FIG. 1 is an oblique top elevational view of a lighting device in accordance with a first embodiment of the present invention.

FIG. 2 is a front view of the lighting device in accordance with the first embodiment of the present invention.

FIG. 3 is a schematic drawing illustrating a light emitting status of the lighting device in accordance with the first embodiment of the present invention.

FIG. 4 is a schematic drawing of an alternate form of the lighting device in accordance with the first embodiment of the present invention.

FIG. 5 is a front view of a lighting device in accordance with a second embodiment of the present invention.

FIG. 6 is an oblique top elevational view of a lighting device in accordance with a third embodiment of the present invention.

FIG. 7 is a sectional view of a lighting device in accordance with a fourth embodiment of the present invention.

### DETAILED DESCRIPTION OF THE PREFERRED EMBODIMENT

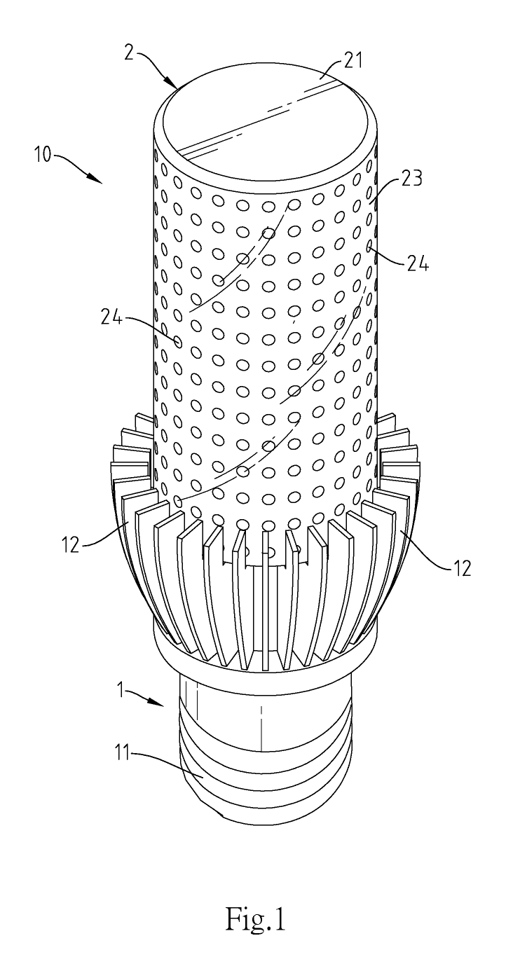

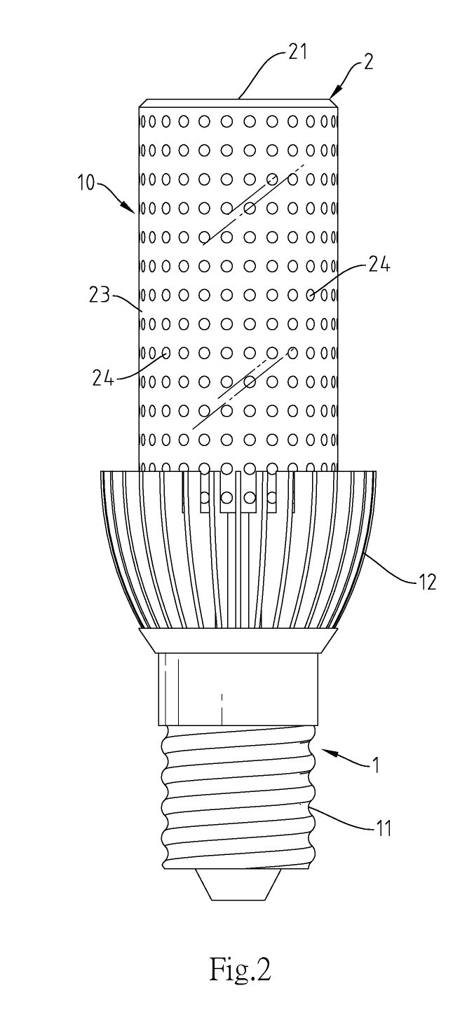

Referring to FIGS. 1-3, a lighting device with uniform illumination in accordance with a first embodiment of the present invention is shown. The lighting device 10 comprises a lamp holder 1, and a light guide prism 2.

The lamp holder 1 comprises an electric connector 11, a heat sink 12, and a light-emitting diode 13. The heat sink 12 is a one piece member comprising a plurality of radially arranged radiating fins. The heat sink 12 is mounted at a top side of the electric connector 11. The light-emitting diode 13 is mounted in the heat sink 12 so that the heat generated during the operation of the light-emitting diode 13 can be directly transferred to the heat sink 12 for quick dissipation.

The light guide prism 2 comprises a reflective layer 21 located at a top end thereof, and a light-incident surface 22 located at an opposing bottom end thereof. The reflective layer 21 is a metal coating layer made by splutter deposition to provide a mirror effect. The light guide prism 2 can be a cylindrical prism, polygonal prism, petal-shaped prism or spiral-shaped prism, or a prism having an irregular shape. The light guide prism 2 further comprises a light-emitting surface 23 extending around the periphery thereof between the reflective layer 21 and the light-incident surface 22, and a plurality of recessed refractive surface portions 24 located in the light-emitting surface 23. The recessed refractive surface portions 24 can be smoothly curved concave surface portions, facets or irregularly curved surface portions for refracting and diffusing light. Further, the recessed refractive surface portions 24 are arranged in an array and evenly distributed over the periphery of the light guide prism 2 so that the periphery of the light guide prism 2 exhibits the shape of an uneven surface. The lamp holder 1 and the light guide prism 2 are assembled by directly fastening the light guide prism 2 to the heat sink 12 of the lamp holder 1 to aim the light-incident surface 22 of the light guide prism 2 at the light-emitting diode 13 of the lamp holder 1.

Thus, when the lighting device is in use, the emitted light of the light-emitting diode 13 is directly projected into the light-incident surface 22 of the light guide prism 2 and then reflected by the reflective layer 21 toward the light-emitting surface 23 and the recessed refractive surface portions 24. At this time, a part of the reflected light is directly projected out of the light-emitting surface 23, and the other part of the reflected light is projected into the recessed refractive surface portions 24 and then refracted and diffused by the recessed refractive surface portions 24 to go out of the light guide prism 2 through the periphery thereof in a uniform manner. Thus, the light guide prism 2 of lighting device 10 can provide enhanced uniformity and brightness of lateral illumination, creating a dramatic illumination effect.

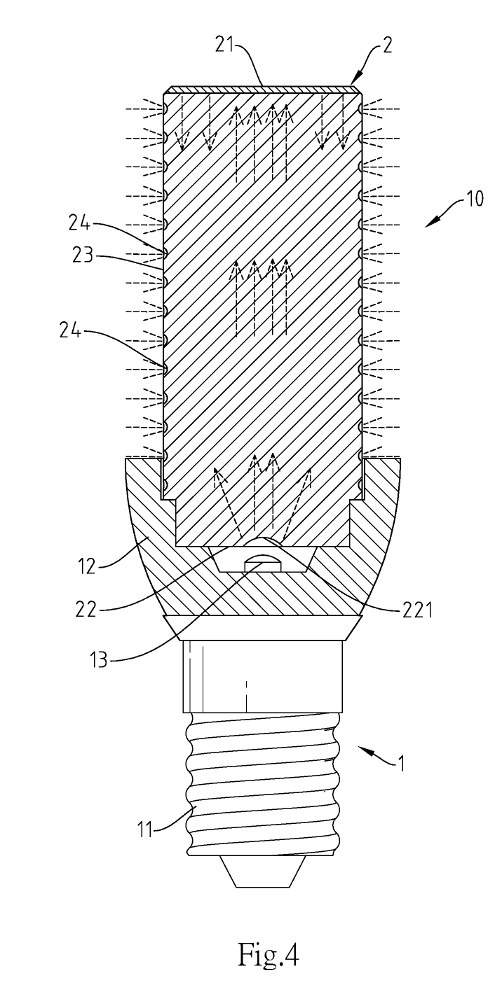

Referring to FIG. 4, in an alternate of the first embodiment of the present invention, the light guide prism 2 of the lighting device 10 comprises a recessed refractive surface portion 221 located at the center of the light-incident surface 22 and facing toward the light-emitting diode 13. Thus, the light emitted by the light-emitting diode 13 is primarily refracted by the recessed refractive surface portion 221 toward the reflective layer 21, and then reflected by the reflective layer 21 toward the light-emitting surface 23 and the recessed refractive surface portions 24, and then secondarily refracted and diffused by the recessed refractive surface portion 24, creating uniform lateral illumination.

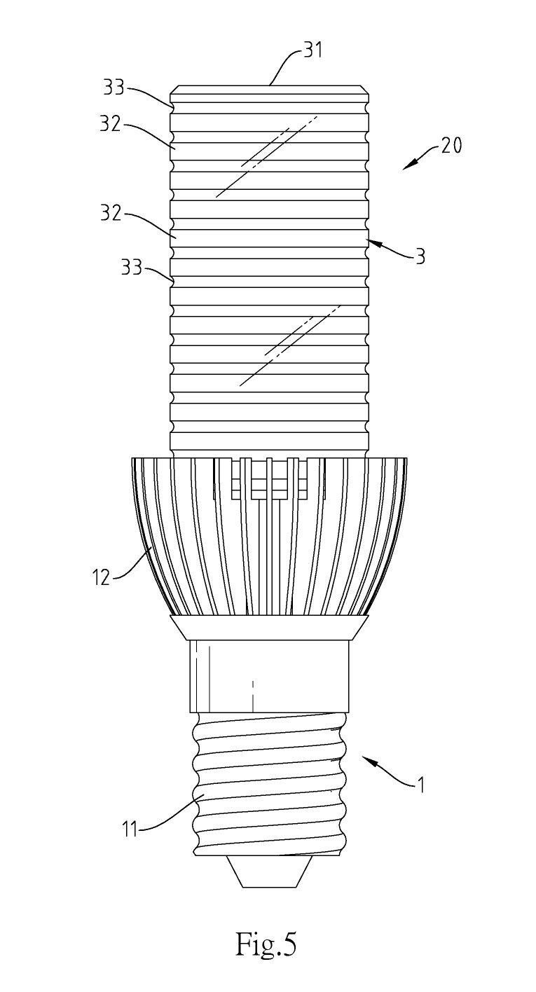

Referring to FIG. 5, a lighting device 20 in accordance with a second embodiment of the present invention is shown. As illustrated, the lighting device 20 comprises a lamp holder 1 and light guide prism 3. The structure of the lamp holder 1 is same as the lamp holder of the aforesaid first embodiment. The light guide prism 3 comprises a reflective layer 31 located at a top end thereof, a plurality of light-emitting surface portions 32 and a plurality of recessed refractive surface portion 33 respectively extended around the periphery thereof and alternatively arranged at different elevations. The recessed refractive surface portions 33 can be endless grooves of any of a variety of cross section designs horizontally or spirally extending around the periphery of the light guide prism 3 at different elevation for refracting and diffusing light. Further, the light guide prism 3 can be a cylindrical prism, polygonal prism, petal-shaped prism or spiral-shaped prism, or a prism having an irregular shape. In installation, the light guide prism 3 is fastened to the heat sink 12 of the lamp holder 1, keeping the light-emitting diode 13 of the lamp holder 1 to face toward the bottom end of the light guide prism 3.

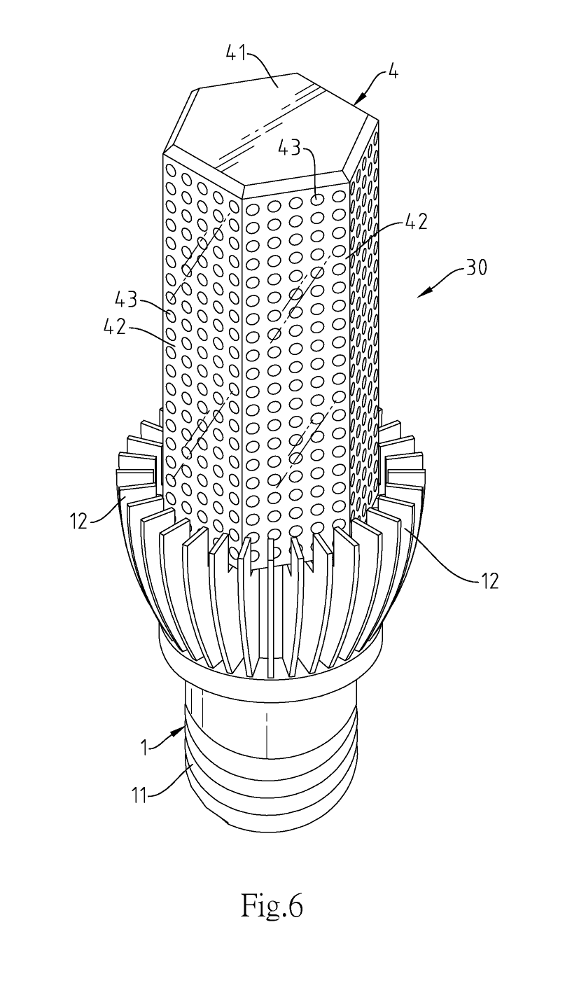

Referring to FIG. 6, a lighting device 30 in accordance with a third embodiment of the present invention is shown. As illustrated, the lighting device 30 comprises a lamp holder 1 and light guide prism 4. The structure of the lamp holder 1 is same as the lamp holder of the aforesaid first embodiment. The light guide prism 4 is a polygonal prism, comprising a reflective layer 41 located at a top end thereof, a plurality of light-emitting surfaces 42 arranged around the periphery thereof, and a plurality of recessed refractive surface portions 43 located in the light-emitting surfaces 42. The recessed refractive surface portions 43 can be smoothly curved concave surface portions, facets or irregularly curved surface portions for refracting and diffusing light. Further, the recessed refractive surface portions 43 are arranged in an array in each light-emitting surface 42 of the light guide prism 2. In installation, the light guide prism 4 is fastened to the heat sink 12 of the lamp holder 1, keeping the light-emitting diode 13 of the lamp holder 1 to face toward the bottom end of the light guide prism 4.

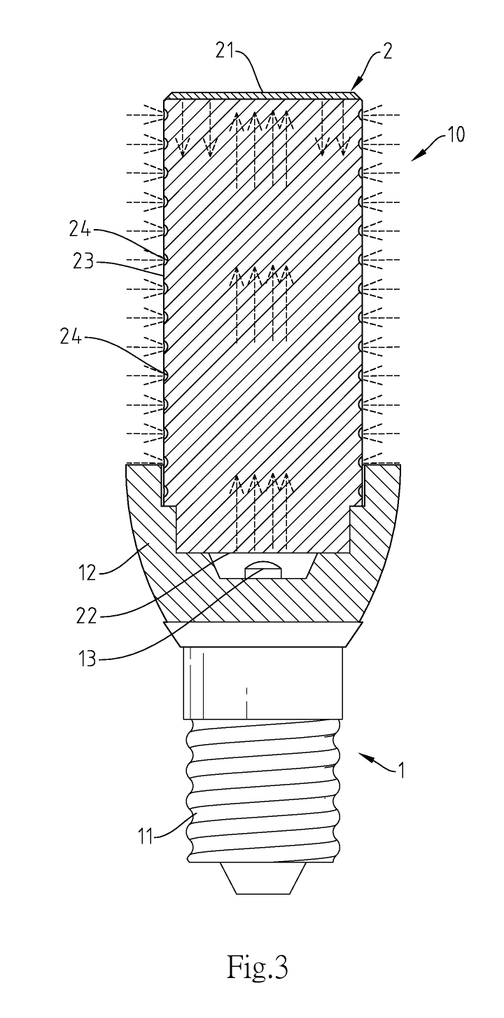

Referring to FIGS. 3-6 again, when the lighting device 20 or 30 of the second or third embodiment of the present invention is in use, the emitted light of the light-emitting diode 13 is directly projected into the bottom end of the light guide prism 3 or 4 toward the reflective layer 31 or 41, and then reflected by the reflective layer 31 or 41 toward the light-emitting surfaces 32 or 42 and the recessed refractive surface portions 33 or 43. At this time, a part of the reflected light is directly projected out of the light-emitting surfaces 32 or 42 to the outside open air, and the other part of the reflected light is projected into the recessed refractive surface portions 33 or 43 and then refracted and diffused by the recessed refractive surface portions 33 or 43 to go out of the light guide prism 3 or 4 in a uniform manner. Thus, the light guide prism 3 or 4 of lighting device 20 or 30 can provide enhanced uniformity and brightness of lateral illumination, creating a dramatic illumination effect.

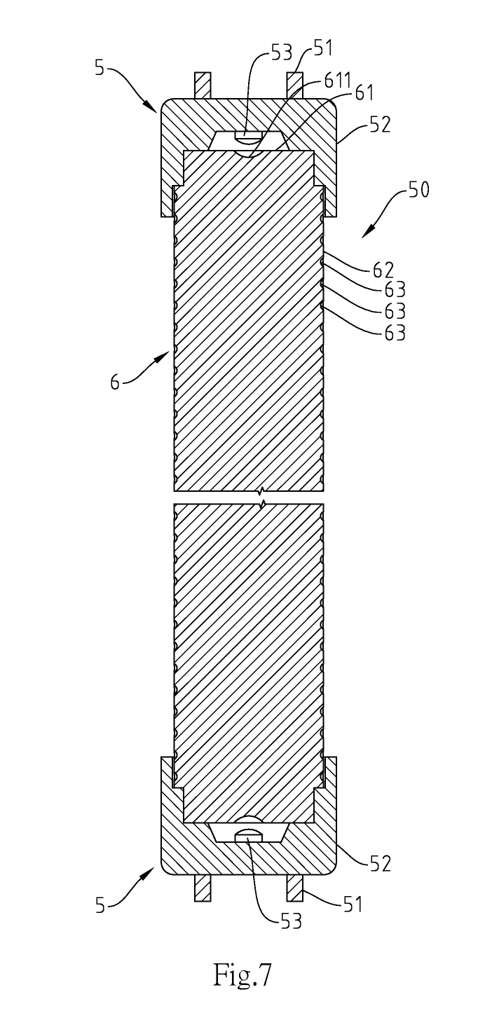

Referring to FIG. 7, a lighting device 50 in accordance with a fourth embodiment of the present invention is shown. As illustrated, the lighting device 50 comprises two lamp holders 5 and a light guide prism 6.

Each lamp holder 5 comprises an electric connector 51, a heat sink 52, and a light-emitting diode 53. The heat sink 52 is mounted at the electric connector 51. The light-emitting diode 53 is mounted in the heat sink 52.

The light guide prism 6 comprises a light-incident surface 61 located at each of two opposite ends thereof, a recessed refractive surface portion 611 located at the center of each light-incident surface 61, a light-emitting surface 62 extending around the periphery thereof between the two light-incident surfaces 61, and a plurality of recessed refractive surface portions 63 located in the light-emitting surface 62 for refracting and diffusing light.

The two lamp holders 5 are respectively attached to the two opposite ends of the light guide prism 6 over the respective light-incident surfaces 61, keeping the respective light-emitting diodes 53 to face toward the respective ends of the recessed refractive surface portion 611. Thus, the emitted light of the light-emitting diodes 53 to into the inside of the light guide prism 6 through the light-incident surfaces 61 and is then refracted and diffused by the recessed refractive surface portion 63 to go out of the periphery of the light guide prism 6 to the outside open air in a uniform manner. Thus, the light guide prism 6 of lighting device 50 can provide enhanced uniformity and brightness of lateral illumination, creating a dramatic illumination effect.

What the invention claimed is:

1. A lighting device, comprising:
a lamp holder comprising an electric connector, a heat sink mounted at said electric connector, and a light-emitting diode located in said heat sink; and
a light guide prism comprising a reflective layer located at one end thereof, a light-incident surface located at an opposite end thereof, a light-emitting surface extending around the periphery thereof, and a plurality of recessed refractive surface portions located in said light-emitting surface for refracting and diffusing light;
wherein the light emitted by said light-emitting diode is projected into said light-incident surface toward said reflective layer, and then reflected by said reflective layer toward said light-emitting surface and said recessed refractive surface portions and then refracted and diffused out of the periphery of said light guide prism in a uniform manner by said recessed refractive surface portions.

2. A lighting device, comprising:
two lamp holders, each said lamp holder comprising an electric connector, a heat sink mounted at said electric connector, and a light-emitting diode located in said heat sink; and
a light guide prism connected between said two lamp holders, said light guide prism comprising a light-incident surface located at each of two opposite ends thereof and respectively facing toward the light-emitting diode of the respective said lamp holder, a light-emitting surface extending around the periphery thereof between said two light-incident surfaces, and a plurality of recessed refractive surface portions located in said light-emitting surface for refracting and diffusing light;
wherein the light emitted by each said light-emitting diode is projected through one respective said light-incident surface to the inside of said light guide prism toward said light-emitting surface and said recessed refractive surface portions and then refracted and diffused out of the periphery of said light guide prism in a uniform manner by said recessed refractive surface portions.
